(19) United States
(12) Patent Application Publication
(10) Pub. No.: US 2003/0212577 A1
(43) Pub. Date: Nov. 13, 2003

(54) Method of improving prescription fulfillment in association with pharamaceutical sample distribution

(76) Inventor: Steven A. Nichtberger, Villanova, PA (US)

Correspondence Address: MERCK AND CO INC, P O BOX 2000, RAHWAY, NJ, 070650907

(21) Appl. No.: 10/144,573

(22) Filed: May 13, 2002

(51) Int. Cl. G06F 17/60

(52) U.S. Cl. 705/2

(57) ABSTRACT

A method of improving the fulfillment of prescription orders by patients, characterized by the steps of a medical professional writing a prescription utilizing a paperless prescription writing system, typically at the point-of-care, for treatment of a patient's conditions; transmitting the paperless prescription to a pharmacy for fulfillment; and contemporaneously with writing and transmitting the prescription, distributing a sample of the pharmaceutical prescription to the patient. Pharmaceutical product identification codes associated with the sample and patient identification information are electronically transmitted to a pharmacy for fulfilling the prescription. The sample distribution, prescription order, and prescription fulfillment information are transmitted to a prescription/sample distribution database for distribution to pharmaceutical manufacturers, pharmacies, advertisers, etc. The prescription/sample distribution data may be utilized to generate statistical analyses of patient's prescription fulfillment and sample distribution.

### FIELD OF THE INVENTION

This invention relates to a method of improving prescription fulfillment, wherein a paperless prescription is submitted to a pharmacy, in association with the distribution of a sample of the prescribed medication to the patient. The prescription and sample distribution data are stored in a remote database, accessible by a host computer and transmitted to the pharmaceutical manufacturer, clearinghouse, etc.

### BACKGROUND OF THE INVENTION

Short term supplies of pharmaceutical products, over-the-counter and prescriptive, in the form of samples, are frequently distributed by physicians to their patients as a free service in order to facilitate product trials, and allow patients and physicians to determine if a particular product is either safe, effective, and/or well tolerated for the intended use. These samples also benefit the manufacturer and marketer of the product to the extent that they drive prescribing behavior by prescribers to select the sampled brand versus another brand in the prescribing decision process. These product samples are typically provided without charge to potential prescribers including physicians and other health care specialists who are licensed to prescribe medications. Pharmaceutical samples represent a valuable offering to physicians and patients that is typically made by pharmaceutical representatives, i.e. sales persons, who use the samples as a selling resource to help gain access to the offices of physicians to facilitate the promotion of their products.

Frequently, in addition to distribution of a product sample to a particular patient, a physician or other qualified medical professional will generate a prescription for the product that the patient will need to have filled by a pharmacist. The sample is generally provided to the patient, among other things, to facilitate immediate initiation of the product, and to determine if the product is effective, safe, and/or well tolerated by that patient for the relevant ailment. While using the sample product, the patient is expected to seek to fulfill the prescription for the pharmaceutical product so that when the sample quantity is used, additional quantities of the product are available to the patient. However, for a myriad of reasons many patients fail to submit their prescriptions to a pharmacy for fulfillment, whether or not the sample was well tolerated and/or effective. Therefore, the prescription for an aliment is often not filled, and the medication is not continued after the sample is administered. This failure of fulfillment is a very costly event for pharmaceutical manufacturers and marketers, and detrimental to patients. It is anticipated that pharmaceutical companies would readily pay pharmacy benefit managers (PBMs) and pharmacies substantial fees for systems to be implemented that would enhance fulfillment of prescriptions that are generated by licensed medication prescribers.

One current trend in the pharmaceutical benefits management (PBM) and pharmaceutical industries is to improve appropriate use of pharmaceuticals to reduce overall healthcare costs and improve patient satisfaction. Among other things, this involves improving patient fulfillment and compliance. To that end, many computerized, prescription writing management systems have been proposed and developed. These systems are designed to facilitate rapid electronic, paperless prescription writing at the point-of-care, and electronic transmission of the prescription to a selected pharmacy and/or PBM for fulfillment thereof.

Paperless and electronic prescription writing systems provide computer-controlled, electronic software and hardware suitable for quick and easy use by a prescriber. U.S. Pat. No. 5,845,255 to Mayaud, issued Dec. 1, 1998, incorporated herein in its entirety by reference thereto, teaches an electronic prescription creation system for use by a prescription writer. The system provides licensed prescription writers, e.g. physicians, with real-time ability to review medical references, pharmaceutical and patient data, and write a paperless/electronic prescription at the place where medical examination/treatment occurs (i.e., point-of-care) based on current medical literature, patient condition and insurance coverage.

One objective of the present invention is to improve fulfillment of prescription orders made in association with a sample distribution. Another objective of the invention is to improve the distribution and notoriety of promotional information and samples relating to pharmaceutical medications. Still another objective is to assist physicians, pharmaceutical manufacturers, and others in obtaining patient feedback regarding their experience with prescribed pharmaceutical products. While yet another objective is to collect demographic data regarding patient utilization, type and quantity of pharmaceutical samples distributed, as well as utilizing the data to recognize prescribers and patients sampling the products. These and objectives of the present invention will become readily apparent to those skilled in the art after reviewing the specification and claims herein after.

### SUMMARY OF THE INVENTION

The present invention is directed to a method of improving prescription fulfillment by a patient, characterized by the steps of:

providing a paperless prescription writing system to the medication prescriber;

identifying a patient;

identifying a medication to be prescribed to the patient;

verifying the sample medication identification information for the prescribed medication, and entering the information into the paperless prescription writing system;

distributing a sample of the prescribed medication to the patient, wherein the sample contains medication identification information;

generating a paperless prescription for the prescribed medication;

transmitting information regarding the prescription and sample to a prescription/sample distribution database; and

transmitting the paperless prescription for the prescribed medication to a pharmacy for fulfillment.

### BRIEF DESCRIPTION OF THE DRAWINGS

In accordance with the present invention, the method of improving prescription fulfillment may be further characterized by illustrations, wherein:

FIG. 1 is a screen display of a computerized prescription fulfillment system containing activation “buttons” for transmitting a paperless prescription and sample distribution information; and

FIG. 2 is a schematic in elevation of the steps of the method for improving prescription fulfillment.

### DETAILED DESCRIPTION OF THE INVENTION

The present invention is directed to a method of improving prescription fulfillment in association with pharmaceutical sample distribution. While the system eliminates the need for a paper prescription provided by a prescriber to the patient for fulfillment at a pharmacy, another important and novel aspect of the invention is that it fundamentally changes the default position on fulfillment from that of an unfilled status to filled prescription status. With minor amendments and additions, the method of the invention may be practiced in association with conventional electronic/paperless prescription writing and transmission systems.

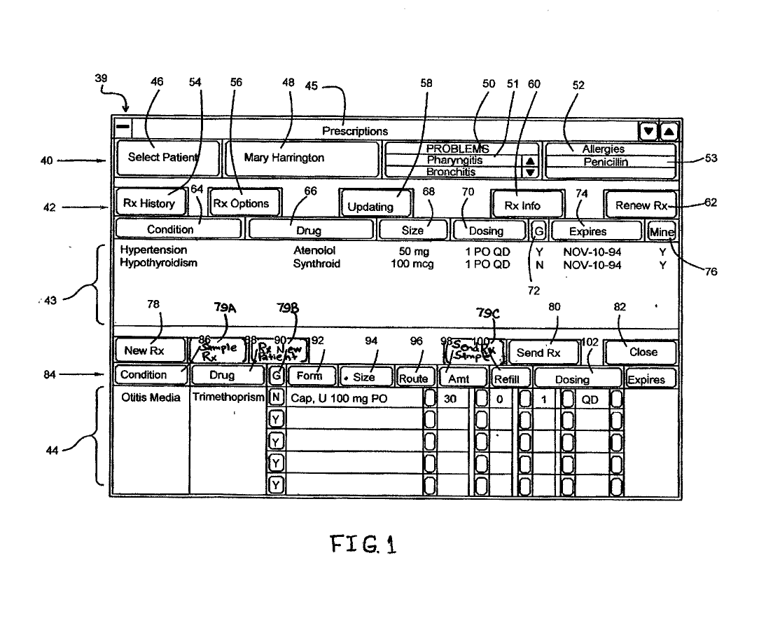

One such conventional system currently being utilized to create an electronic/paperless prescriptions is illustrated in FIG. 1 and described in U.S. Pat. No. 5,845, 255 to Mayaud, incorporated herein by reference in its entirety. However, the method of the present invention may be adapted for use with many different prescription writing and transmitting systems, as will become apparent to those skilled in the art upon reviewing the description hereof.

In accordance with one embodiment of the invention practicable in conjunction with a conventional prescription writing/transmission system, FIG. 1 provides prescription creation screen 39. The screen exists as a part of a electronic/paperless prescription creation system includes an array of buttons that may be activated by a licensed medication prescriber, e.g. physicians, osteopaths, veterinarian, pharmacists and the like, to prescribe a pharmaceutical medication to a patient. The medication may be prescribed after physical examination and/or discussion with the patient by the prescriber to determine a suitable medication and regiment to treat a medical condition demonstrated by the patient, typically, at the point-of-care of the patient, i.e. medical office, clinic, hospital, and the like. Near the top of screen 39 is patient features bar 40 below which prescription features bar 42 coordinates features necessary to review current therapy and order changes in treatment or order new treatment for a selected patient. Prescription history zone 43 extends across the middle of the screen. The lower screen portion contains prescribing zone 44, and screen title 45 (“Prescriptions”) appears at the top of the screen. Typically, Patient Feature bar 40 contains Select Patient button 46, Selected Patient Indicator button 48, Problem button 50, and Patient Allergies button 52. In one example, pressing or otherwise activating Problem button 50 or Allergies button 52 will access a remote database containing a patient's current medical history. Accessing the remote database opens window or screen listing problems or allergies from which a medical professional may select new problems or allergies to add to the patient's records or delete conditions that are no longer active. In implementing the present invention to the prescription writing system, FIG. 1 may further contain buttons 79A, 79B and 79C. Sample Distribution button 79A may be selected when the medication prescriber decides to prescribe a medication for which a sample of the medication will be distributed to the patient. Activation of the Sample Distribution button and inputting sample identification information, formulary and quantity of medication, or alternatively scanning a prescription identification code located on a sample package will activate the system to automatically complete medication information required in the prescription. At the time of distribution of the sample, Sample Distribution Transmission button 79B may be activated to transmit sample distribution information to a prescription/sample distribution database for recording the data. If the patient is a first-time user of the prescribed medication New Patient/Sample Distribution button 79C may be activated. Generally, after the prescription is generated, a prescriber may activate the Prescription Transmission button 80 to send the prescription to a conventional pharmacy, mail order pharmacy, or the prescription may be bifurcated into two or more portions for simultaneous fulfillment by conventional and mail order pharmacies.

Prescription issuance and sample distribution information may be transmitted and maintained in a prescription/sample distribution database. The prescription/sample distribution information provided to the database may contain the patient and prescriber information, sample distribution information, and whether the patient is a first-time user of the prescribed medication. The prescription/sample data may be formatted to include: 1) general information contained on a prescription, 2) sample identification information, and 3) whether the patient is a first-time or existing user of the prescribed medication. General patient information may be accessible by the prescription writing system for review of medical and drug histories by the prescriber when writing future prescriptions. The prescription/sample data may be formatted, optionally deleting specific prescriber and patient information, and provided to pharmaceutical manufacturers, advertisers, record maintenance organizations, clearing houses, and the like. The data may be utilized to determine product suitability, desirability, safety, efficacy, etc. The data may also be utilized to determine whether medication prescribers are distributing prescription samples to patients, whether the distribution is to a new or existing patient, and patient demographics, e.g. gender, age, geographical location, etc. These and other uses of the sample distribution database will become apparent to those skilled in the art. Generally, other information maintained in the database may include product name, formulary, quantity of samples distributed, patient prescription number, date, patient insurance information, patient identification, etc. According to one method of the invention, the data may be transmitted to the patient's insurance provider for coverage verification and co-payments along with conventional information to be recorded in the patient's medical history, prescription history, prescription fulfillment history, and the like.

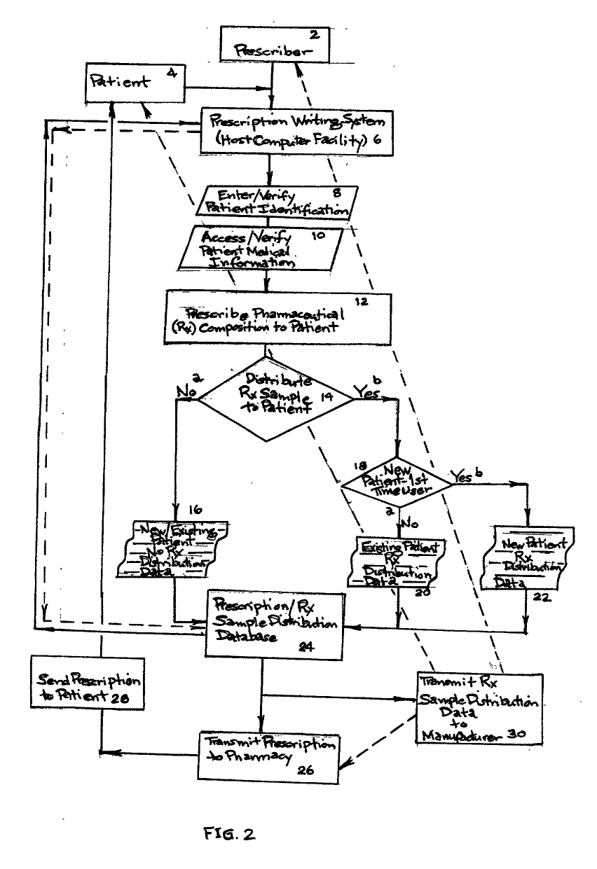

In accordance with FIG. 2, illustrated is a schematic of a preferred embodiment of the method of improving the fulfillment of prescription orders in association with distribution of a sample of the prescribed medication. While the steps of the method are numbered for reference purposes, several of the steps may be performed in other logical sequences that will become readily apparent to those skilled in the art. Prescriber 2, a licensed medication prescriber, authorized to write and issue prescriptions, generally meets with patient 4 or receives information thereabout of a need for prescriptive medical for treatment of a particular ailment or medical condition. Typically, after examining the patient and/or determination of the proper course of treatment and medication, the prescriber will often prescribe one or more pharmaceutical medications for treatment of the condition. Generally, the prescriber may access paperless prescription writing system 6 via a personal computer, personal digital assistant or other computerized system, optionally equipped with means for scanning a uniform products code or other identification information. The prescription writing system is generally linked to a host computer facility able to read and write data to remote databases for medical, drug and insurance histories as well as access on-line medical and pharmaceutical references. After diagnosing the patient's ailment/condition and selecting the proper pharmaceutical medication for treatment, the prescriber may enter patient identification information 8 into the system. Patient identification information may be selected from social security number, employee identification number, patient health insurance identification number, and the like. Optionally, the patient identification information may be scanned from a patient identification card or manually entered into the system to access a patient database containing medical and prescription histories, medical insurance coverage and co-payment, approved formularies, and the like (assuming the patient information is already in the system). In other instances, wherein the patient is new or there is no information existing in the system database, patient identification information may be manually entered to verify identification, medical insurance coverage, etc., and establish a new patient database.

Typically, after patient identification information is entered, the prescriber may access the prescription computer screen already containing patient information. Patient medical coverage information 10 may be entered into the system to identify the patient's medical insurance coverage, preferred formularies, prescription history, and the like if the same is not automatically provided by default upon entering the patient identification information or scanning a patient identification card. In one embodiment, the patient may enter a “PIN” number into the system to consent to a co-payment of medical insurance coverage or other cost associated with fulfillment of the prescription. Conventionally, the prescription writing system may provide medical references and pharmaceutical product databases to assist the prescriber in writing the prescription at the point-of-care. By utilizing up-to-date patient information, available insurance coverage, medical references, and pharmaceutical medication information, the prescriber may be enabled to write a better prescription at the point-of-care.

Next, the prescriber must select pharmaceutical medication 12 for the patient in accordance with her or his condition. Upon selecting a medication, the prescriber physically verifies the identity of the sample or by scanning identification information on the sample package into the system to confirm the identity and medication information regarding the sample, and to verify that the sample is in accord with the prescribed medication. Afterwards, the prescriber may distribute the pharmaceutical sample to the patient for administration in accordance with a prescribed regiment. The system queries the prescriber as to whether a sample is being distributed to the patient 14. If the answer to the query is “no” 14a, the prescriber may activate Send Prescription button 80, wherein the prescription/no sample distribution data 16 is transmitted to prescription/sample distribution database 24. However, if the answer to the sample distribution query is “yes” 14b, the prescriber activates Sample Distribution button 79A of FIG. 1 to affirmatively answer the query. Thereafter, the system queries the prescriber as to whether the patient is a new, first-time user of the medication 18. If the answer to the query is “no” 18a, the prescriber may activate Send Prescription button 80, and existing patient-sample distribution data 20 will be transmitted to prescription/sample distribution database 24. If the answer to the query is “yes” 18b, the prescriber may activate Sample Distributed-New Patient button 79B of FIG. 1, and new, first-time user sample distribution data 22 will be transmitted to prescription/sample distribution database 24. The electronic prescription, after being routed through and stored in database 24 may be forwarded to pharmacy 26 for filling the same. The prescription data may be stored in remote databases for patient medical and drug histories. Thereafter, the pharmacy fills and transmits the prescription to the patient 28 for administration.

The prescription/sample distribution data, containing prescription and sample distribution information, may be conveniently formatted and transmitted to the pharmaceutical manufacturer 30 or others for statistical analysis of sample distribution data. The prescription/sample distribution database may be formatted and stored on media selected from compact disc, floppy disc, tape, paper and the like. Pharmaceutical manufactures may desire to determine the acceptance of a new medication by physicians and patients, or whether a prescriber is distributing the sample to new or existing patients. Optionally, the manufacturer may recognize prescriber 2, patient 4 and/or pharmacy 26 for prescribing the medication, taking the medication, and filling the prescription, respectively. Prescription and sample distribution data may assist a pharmaceutical manufacturer in determining patient acceptance, market trends, suitability of use, adverse effects, and the like.

The sample may be of sufficient quantity to provide relief from the diagnosed aliment or medical condition until a prescription is distributed by a conventional pharmacy and/or PBM. A “conventional” pharmacy is defined as a neighborhood retail store that may display and sell over-the-counter medications and other retail merchandise. A pharmaceutical benefits manger (PBM) is defined as a mail order pharmacy that generally automatically dispense and distribute prescriptive medication in larger quantities than a conventional pharmacy.

Typically, sample identification information such as formulary, quantity, lot number, etc. may be identified or summarized by a uniform product code (UPC) or other methods known to those skilled in the art. The sample package identifier may be scanned or otherwise entered into the prescription writing system to automatically generate medication information into the prescription screen (FIG. 1). After the sample information has been entered into the system, it may be merged with the patient identification to complete a default prescription. Thereafter, the prescriber may simply verify the default information automatically generated by the system, or simply delete and enter other information to change the formulary, number of refills, quantity of medication, etc. Finally, the prescription is completed and electronically transmitted to pharmacy or PBM chosen by the patient for filling.

Another embodiment of the invention provides a method of improving prescription fulfillment by a patient in need of prescription medication, characterized by the steps of:

providing a paperless prescription writing system to a medication prescriber;

identifying a patient in need of prescription medication;

identifying a medication to be prescribed to the patient;

verifying a sample identification information for the prescribed medication, and entering the information into the paperless prescription writing system;

distributing a sample of the prescribed medication to the patient, wherein the sample contains medication identification information;

generating a paperless prescription for the prescribed medication to treat a condition exhibited by the patient;

transmitting information of the prescription and sample distribution electronically to a prescription/sample distribution database; and

transmitting the paperless prescription for the prescribed medication to a pharmacy for filling,

wherein prescription generation, prescription transmission, and distribution of the sample to the patient are contemporaneously performed.

Prior to activating the Prescription Transmission button, the prescription should contain all the information contained in a conventional paper prescription necessary for a pharmacist to fill the same, e.g. patient information, medication identification code, quantifier, number of refills, prescriber name and license number, etc. Optionally, the prescription transmission may be bifurcated, wherein a small portion thereof can be transmitted to a conventional pharmacy for immediate fulfillment, while a large portion thereof may be transmitted to a PBM for fulfillment if the medication is for long-term treatment of an ailment. Utilization of sample identification code and quantifier may assist in reduce errors in generating and dispensing the correct formulary and quantity of medication prescribed. With minor amendments to the software of a conventional, electronic prescription writing system know to those skill in the art, the method of the instant invention may be readily practiced with those systems. In utilizing electronic transmission, the prescription may be rapidly received by the pharmacy, fulfilled and provided to the patient.

Recordation of patient and sample identification information by a pharmaceutical manufacturer can be utilized to maintain statistical information regarding the quality and quantity of the sample medications distributed and the geographical location of distribution. Similarly, the identical information can be utilized by a pharmaceutical manufacturer to enhance marketing strategies, provide recognition to the prescriber and patient in the form of advertisement and product literature, product promotions, coupons, rebates, etc. Additional uses of the patient and sample information will become apparent to those skilled in the art.

Still another embodiment of the invention is directed to a method of improving prescription fulfillment by a patient in need of pharmaceutical medication in association with distribution of a sample of the medication to the patient, characterized by the steps of:

providing a paperless prescription writing system to a medication prescriber selected from a physician, osteopath, veterinarian, pharmacist, and the like, the prescription system comprising an electronic, computer controlled system, of hardware and software suitable for generation a paperless prescription for pharmaceutical medication and electronically transmitting the prescription to a pharmacy for fulfillment, wherein the system is linked to a host computer facility;

identifying a patient utilizing the prescription writing system, comprises inputting into the prescription writing system, patient information selected from social security number, health insurance identification number, employee number, and combinations thereof;

identifying a medication to be prescribed to the patient, comprising a health care professional assessing a patient need for prescription medication, wherein the assessment may include physical examination or patient explanation of a condition;

verifying the sample medication identification information for the prescribed medication and entering the information into the paperless prescription writing system;

distributing a sample of the prescribed medication to the patient, wherein the sample contains medication identification information selected from a uniform product code, pharmaceutical manufacturer lot code, and combinations thereof;

generating a paperless prescription for the prescribed medication, wherein the paperless prescription, comprises information selected from a prescription number, patient name, medication name, medication formulary, medication quantity, and combinations thereof;

transmitting information of the prescription and sample distribution electronically to a prescription/sample distribution database, wherein the prescription/sample distribution database comprises prescription number and date; prescriber name and license number; patient name; medication name, formulary, and quantifier; sample name, formulary, and quantifier; and new-first time or existing user of medication; and

transmitting the paperless prescription to a pharmacy for fulfillment, wherein the pharmacy is selected from a conventional pharmacy, mail order pharmacy, and combinations thereof,

wherein the patient is able to administer the prescriptive medication, via the sample, prior to the prescription being filled, and the prescription/sample distribution database provides a record of prescription generation and sample.

Still another embodiment of the invention is directed to the prescription/sample distribution database produced by the method of improving prescription fulfillment, wherein the database is formatted into a form presentable to the user and stored on media selected from compact disc, floppy disc, tape, paper and the like. The database may be used by pharmaceutical manufactures, advertisers, clearinghouses and the like to determine marketing trends, distribution of pharmaceutical sample by medication prescribers, product acceptance, as well as others that will become apparent to those skilled in the art.

The sample identification code will generally indicate the medication, its formulary, lot number and/or uniform product codes, and manufacturer thereof. The patient identification information may contain the patient's name, address, telephone number, social security, medical insurance coverage, medical history information, medication history information, allergies, pre-existing medical conditions, and any other information known to those skilled in the art that may be necessary to completely identify the patient's medical condition. Generally, the prescription writing system will be connected to a database via the world-wide-web or other means to provide real time verification of the patient's medical coverage.

Typically, distribution of a sample of prescribed medication to the patient is contemporaneous with the generation and transmission the prescription to the pharmacy. The patient is provided with the medication for immediate administration to treat a particular aliment, and the prescription is quickly received by the pharmacy for fulfillment. Optionally, knowing the estimated time required by the pharmacy to fill the prescription, the prescriber may provide a sufficient quantity of sample to the patient to treat the ailment until the prescription is received by the patient.

What is claimed is:

1. A method of improving prescription fulfillment by a patient, comprising the steps of:
providing a paperless prescription writing system to a medication prescriber;
identifying a patient;
identifying a medication to be prescribed to the patient;
verifying the sample medication identification information for the prescribed medication, and entering the information into the paperless prescription writing system;
distributing a sample of the prescribed medication to the patient, wherein the sample contains medication identification information;
generating a paperless prescription for the prescribed medication;
transmitting information regarding the prescription and sample to a prescription/sample distribution database; and
transmitting the paperless prescription for the prescribed medication to a pharmacy for fulfillment.

2. The method of improving prescription fulfillment according to claim 1, wherein the prescriber is selected from a physician, osteopath, veterinarian, pharmacist, and the like.

3. The method of improving prescription fulfillment according to claim 2, wherein the paperless prescription writing system is an electronic, computer system comprising hardware and software linked to a host computer facility suitable for generating a paperless prescription for pharmaceutical medication and electronically transmitting the prescription to a pharmacy for fulfillment.

4. The method of improving prescription fulfillment according to claim 3, wherein identifying a patient, comprises inputting into the prescription writing system, patient information selected from social security number, health insurance identification number, employee number, and the combinations thereof.

5. The method of improving prescription fulfillment according to claim 4, wherein identifying the medication to be prescribed to the patient, comprises a health care professional assessing a patient need for prescription medication, wherein the assessment may include physical examination or patient explanation of a medical condition.

6. The method of improving prescription fulfillment according to claim 5, wherein the sample medication identification information comprises, information selected from a uniform product code, lot number, medication identity, formulary, manufacturer, and combinations thereof.

7. The method of improving prescription fulfillment according to claim 6, wherein generating the paperless prescription and transmitting of th e prescription to a pharmacy are contemporaneously performed with distributing the sample of medication to the patient.

8. The method of improving prescription fulfillment according to claim 7, wherein the prescription comprises a patient name, patient address, prescription number, date, medication identifier and quantifier.

9. The method of improving prescription fulfillment according to claim 8, wherein fulfillment of the prescription comprises transmission of the prescription to a pharmacy.

10. The method of improving prescription fulfillment according to claim 9, wherein information of the prescription and sample distribution are electronically transmitted to a prescription/sample distribution database.

11. The method of improving prescription fulfillment according to claim 10, wherein the prescription/sample distribution information comprises prescription number and date; prescriber name and license number; patient name; medication name, formulary, number of refills, and quantifier; sample name, formulary, and quantifier; and new-first time or existing user of medication.

12. A method of improving prescription fulfillment by a patient in need of prescription medication, comprising the steps of:
providing a paperless prescription writing system to a medication prescriber;
identifying a patient in need of prescription medication;
identifying a medication to be prescribed to the patient;
verifying a sample identification information for the prescribed medication, and entering the information into the paperless prescription writing system;
distributing a sample of the prescribed medication to the patient, wherein the sample contains medication identification information;
generating a paperless prescription for the prescribed medication to treat a condition exhibited by the patient;
transmitting information of the prescription and sample distribution electronically to a prescription/sample distribution database; and
transmitting the paperless prescription for the prescribed medication to a pharmacy for filling,
wherein prescription generation, prescription transmission, and distribution of the sample to the patient are contemporaneously performed.

13. The method of improving prescription fulfillment according to claim 12, wherein the prescriber is selected from a physician, osteopath, veterinarian, pharmacist, and the like.

14. The method of improving prescription fulfillment according to claim 13, wherein the paperless prescription writing system is an electronic, computer system comprising hardware and software linked to a host computer facility suitable for generating a paperless prescription for pharmaceutical medication and electronically transmitting the prescription to a pharmacy for fulfillment.

15. The method of improving prescription fulfillment according to claim 14, wherein identifying a patient, comprises inputting into the prescription writing system, patient information selected from social security number, health insurance identification number, employee number, and combinations thereof.

16. The method of improving prescription fulfillment according to claim 15, wherein identifying the medication to be prescribed to the patient, comprises a health care professional assessing a patient need for prescription medication, wherein the assessment may include physical examination or patient explanation of a medical condition.

17. The method of improving prescription fulfillment according to claim 16, wherein the sample medication identification information comprises information selected from a uniform product code, pharmaceutical manufacturer lot code, and combinations thereof.

18. The method of improving prescription fulfillment according to claim 17, wherein generating the paperless prescription is performed contemporaneously with distribution of the sample of medication.

19. The method of improving prescription fulfillment according to claim 18, wherein the prescription/sample distribution database comprises prescription number and date; prescriber name and license number; patient name; medication name, formulary, number of refills, and quantifier; sample name, formulary, and quantifier; and new-first time or existing user of medication.

20. The method of improving prescription fulfillment according to claim 19, wherein the prescription/sample distribution database is transmitted to the pharmaceutical manufacturer.

21. A method of improving prescription fulfillment by a patient in need of pharmaceutical medication in association with distribution of a sample of the medication to the patient, comprising the steps of:
providing a paperless prescription writing system to a medication prescriber selected from a physician, osteopath, veterinarian, pharmacist, and the like, the prescription system comprising an electronic, computer controlled system, of hardware and software suitable for generation a paperless prescription for pharmaceutical medication and electronically transmitting the prescription to a pharmacy for fulfillment, wherein the system is linked to a host computer facility;
identifying a patient utilizing the prescription writing system, comprises inputting into the prescription writing system, patient information selected from social security number, health insurance identification number, employee number, and combinations thereof;
identifying a medication to be prescribed to the patient, comprising a health care professional assessing a patient need for prescription medication, wherein the assessment may include physical examination or patient explanation of a condition;
verifying the sample medication identification information for the prescribed medication and entering the information into the paperless prescription writing system;
distributing a sample of the prescribed medication to the patient, wherein the sample contains medication identification information selected from a uniform product code, pharmaceutical manufacturer lot code, and combinations thereof;
generating a paperless prescription for the prescribed medication, wherein the paperless prescription, comprises information selected from a prescription number, patient name, medication name, medication formulary, medication quantity, and combinations thereof;
transmitting information of the prescription and sample distribution electronically to a prescription/sample distribution database, wherein the prescription/sample distribution database comprises prescription number and date; prescriber name and license number; patient name; medication name, formulary, number of refills, and quantifier; sample name, formulary, and quantifier; and new-first time or existing user of medication; and
transmitting the paperless prescription to a pharmacy for fulfillment, wherein the pharmacy is selected from a conventional pharmacy, mail order pharmacy, and combinations thereof,
wherein the patient is able to administer the prescriptive medication, via the sample, prior to the prescription being filled and the prescription/sample distribution database provides a record of prescription generation and sample distribution.

22. The prescription/sample distribution database produced by the method of improving prescription fulfillment according to claim 21.

23. The prescription/sample distribution database produced by the method of improving prescription fulfillment according to claim 21, wherein the database is formatted and stored on media selected from compact disc, floppy disc, tape, and paper.
